(19) United States
(12) Patent Application Publication
(10) Pub. No.: US 2007/0079926 A1
(43) Pub. Date: Apr. 12, 2007

(54) Methods for printed roofing product

(76) Inventors: Naresh R. Mehta, Cranston, RI (US); Jeffrey C. Flath, Warwick, RI (US); Lawrence R. Wallace, North Kingstown, RI (US)

Correspondence Address: David J. Rikkers;Brown Rudnick Berlack Israels, LLP, One Financial Center, Boston, MA, 02111, US

(21) Appl. No.: 11/245,611

(22) Filed: Oct. 7, 2005

(51) Int. Cl. B44C 3/08

(52) U.S. Cl. 156/219; 156/277

(57) ABSTRACT

A method is provided for forming a roofing product. The method includes printing an image representing multiple shingles, multiple roofing tiles and/or multiple wood shakes on a face layer. The face layer and a scrim are combined to form a continuous sheet. The face layer is also embossed. Another method also includes combining a face layer and a scrim to form continuous sheet. A transparent and/or translucent film is provided. An image of multiple shingles, multiple roofing tiles and/or multiple wood shakes is printed on a first side of the film. The first side of the film is laminated to the face layer, opposite the scrim. A method of installation of a roofing product is also provided.

### TECHNICAL FIELD

The present invention is related to roofing products generally and, more specifically, to printed roofing products.

### BACKGROUND

A wide variety of roofing products are available for different roof types and applications. Flat roofs have typically used a white or black membrane. Pitched roofs have often used separate asphalt shingles. The desired appearance of a roof often influences the type of roofing product selected for a particular application. For example, a membrane roofing product is often not used on a pitched roof, as people customarily expect to see shingles on a roof.

Recently, the concept of printing an image of numerous shingles on a roofing membrane has been introduced, giving the appearance of a shingled roof, while maintaining all the advantages of a membrane roof. One example of such a product is the ILLUSIONS® product from Cooley Inc. of Pawtucket, R.I. Membrane roofs typically involve lighter materials than asphalt shingles and can be installed more quickly, as the installation process does not require handling and securing each shingle. Also, wind resistance can be enhanced by a properly secured membrane roof, compared to the wind resistance of asphalt shingles.

### SUMMARY

The present invention is directed toward improving the membrane roofing product. For example, various embodiments of the present invention may enhance the surface of the roofing product by the use of embossing, so as to create a texture and appearance more similar to that of asphalt shingles. Embodiments of the present invention may be used with flat or pitched roofs. In some applications, embossing may reduce glare from the roofing product and may improve safety by enhancing footing of those walking on the roof by reducing the likelihood of slippage. Various embodiments of the invention may also provide for the use of better materials, so as to enhance the performance and/or durability of the membrane.

According to an embodiment of the present invention, a method is provided for forming a roofing product. The method includes printing an image representing multiple shingles, multiple roofing tiles and/or multiple wood shakes on a face layer. The face layer and a scrim are combined to form a continuous sheet. The face layer is also embossed.

According to another embodiment, another method for forming a roofing product is provided. This method also includes combining a face layer and a scrim to form continuous sheet. A transparent and/or translucent film is provided. An image of multiple shingles, multiple roofing tiles and/or multiple wood shakes is printed on a first side of the film. The first side of the film is laminated to the face layer, opposite the scrim.

A further embodiment of the present invention provides a method of installation of a roofing product. The method includes providing an embossed roofing membrane having an image representing multiple courses of shingles roofing tiles and/or wood shakes and representations of shadows formed by a first course and located on a second course. The embossed roofing membrane is located on a roof such that the representations of shadows are located below the course of shingles, roofing tiles or wood shakes to which the representations of shadows correspond.

### BRIEF DESCRIPTION OF THE DRAWINGS

The invention will be apparent from the description herein and the accompanying drawings, in which like reference characters refer to the same parts throughout the different views.

FIG. 1 is an schematic diagram of a roofing membrane according to an embodiment of the present invention; and

FIG. 2 is a flowchart of a method according to an embodiment of the present invention;

FIG. 3 is a flowchart of a method according to an embodiment of the present invention; and

FIG. 4 is a flowchart of a method according to an embodiment of the present invention.

### DETAILED DESCRIPTION

Various embodiments of the present invention are directed toward providing a membrane roofing product that may provide enhanced appearance and/or performance over conventional membrane roofing products.

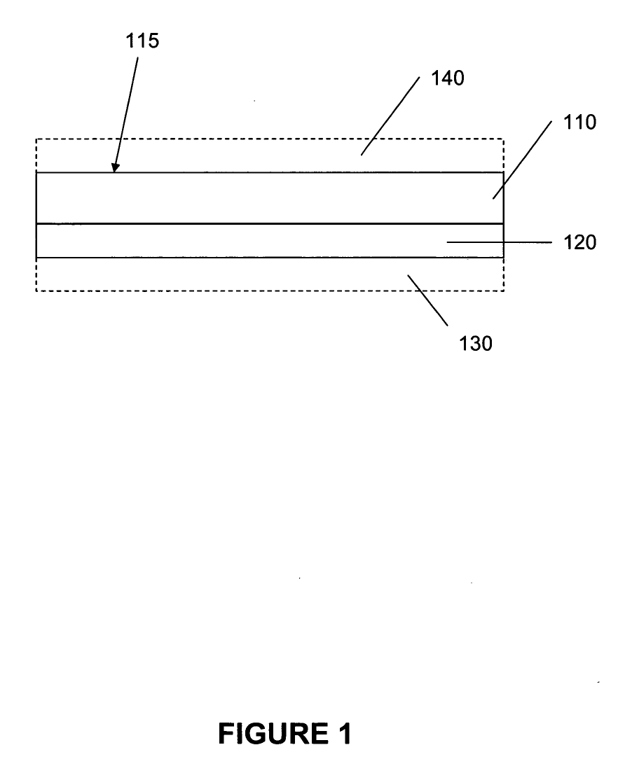

With reference to FIG. 1, an illustrative embodiment of the present invention is a roofing product 100 having a face layer 110 combined with a scrim 120 to form a continuous sheet. An image 115, such as, for example, an image representing multiple shingles, multiple roofing tiles and/or multiple wood shakes is printed on the face layer 110. The face layer 110 is also embossed, so as to provide a texture to the face layer 110. Optionally, a back 130 may also be included and mounted with the face layer 110 and scrim 120, thereby locating the scrim 120 between the face layer 110 and back 130. Also optional is a protective upper layer 140, mounted to the face layer 110 opposite the scrim 120.

The face layer 110 and/or back 130 may be made from a wide variety of materials, including those conventionally used, such as flexible vinyl, polyvinyl chloride (PVC), polyethylene and/or polyester (PET). Additional examples of materials for the face layer 110 according to embodiments of the invention include: ketone ethylene ester, thermoplastic polyolefin, chlorosulfonated polyethylene, chlorinated polyethylene (CPE), ethylene propylene diene monomer (EPDM), metallocene-catalyzed polyethylene, thermoplastic vulcanizate, thermoplastic elastomer and/or polyvinylidene fluoride (PVDF). An example of ketone ethylene ester is ELVALOY® by E. I. du Pont de Nemours and Company of Wilmington, Del. An example of chlorosulfonated polyethylene is HYPALON® from DuPont Performance Elastomers LLC of Wilmington, Del. Examples of metallocene-catalyzed polyethylenes include AFFINITY & ENGAGE by The Dow Chemical Company of Midland, Mich. An example of a thermoplastic vulcanizate is SANTOPRENE by Advanced Elastomer Systems, L. P. of Farmington Hills, Mich.

Optionally, a filler may be combined in the face layer 110 and/or back 130. Examples of fillers include silica based fillers, foaming agents, ceramics, microspheres, fly ash, calcium carbonate, or inorganic minerals. In some cases, the filler may enhance the insulation properties of the roofing product. In forming the face layer 110 and/or back 130, a plasticizer system may be used and, if used, may optionally be based on solid plasticizers.

Additional items may be added to the back 130. Optionally, a fleece may be adhered to the back 130, opposite the scrim 120. Peel and stick technology may be added to the back 130, to provide for the use of an adhesive and a removable sheet to be mounted on the outer side of the back 130. The sheet is removed at the time of installation of the roofing product to expose the adhesive.

The scrim 120 may be formed of a wide variety of materials known in the art. Examples of materials for the scrim 120 include 1000 denier polyester and fiberglass. Fiberglass can be used to provide additional fire protection.

The protective upper layer 140 may be formed by top coating, extrusion and/or by the use of a film. Locating the protective upper layer on the face layer may be performed after printing an image on the face layer and before combining the face layer with the scrim, or may be performed at another time. Top coating may be performed by, for example, spray coating or knife coating. Examples of the top coat include acrylic, vinyl acetate coating and polyvinylidene fluoride. Polyvinylidene fluoride may alternatively be applied as a film. An example of polyvinylidene fluoride film is KYNAR®, available from Westlake Plastics Company of Lenni, Pa. If using a film, the film may be laminated to the face layer 110. In some implementations using polyvinylidene fluoride and/or acrylic, the protective upper layer 140 may provide enhanced self cleaning functionality.

A wide variety of alternatives may be implemented in embodiments of the invention. For example, in one implementation of the invention, the face layer 110, scrim 120, back 130 and/or protective upper layer 140 may be formed of clear polymeric materials. In one implementation, a clear protective upper layer 140 allows the face layer 110 to be seen. Providing a clear face layer 110, scrim 120, back 130 and optional protective upper layer 140 can provide a skylight functionality.

According to various implementations, thermochromic and/or phosphorescent materials may be applied to the face layer 110, back 130 and/or protective upper layer 140 to alter the color of the roofing product. Use of thermochromic materials can be beneficial in improving roof performance and/or efficiency, as the thermochromic materials can provide for a light color roof when hot, thereby reflecting additional heat that is usually undesirable in such circumstances. When conditions are cool, the thermochromic materials can provide a darker color roof, thereby absorbing more solar heat. Examples of thermochromic materials include thermochromic pigments available from H.W. Sands Corporation of Jupiter, Fla. Phosphorescent materials, such as phosphorescent pigment, can be used in the ink used to print the image, the face layer and/or the protective layer. Use of phosphorescent materials can provide a glowing characteristic to the roof or portions of the roof, which may be desirable in some applications. Examples of phosphorescent materials include LUMINOVA® pigments available from Nemoto & Co., Ltd. of Tokyo, Japan.

In a further implementation, post-consumer and/or post-industrial recycled materials up to 100% may be used to form the upper and or lower-layers of the product. In another implementation, materials may be applied to the roofing product to provide radio frequency (RF) and electromagnetic (EM) shielding. Examples of such shielding material include conductive scrim material, such as metal scrim.

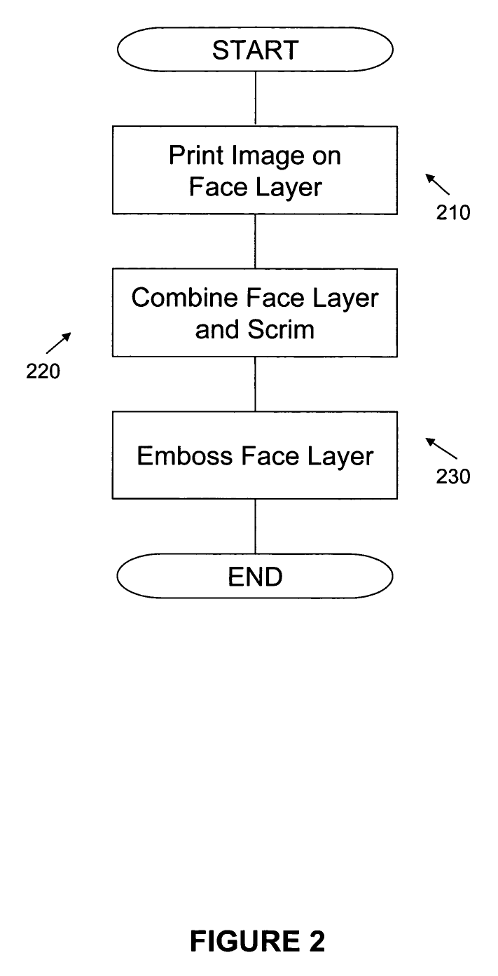

With reference to FIG. 2, an illustrative method 200 of the invention is illustrated for forming a roofing product. The method includes printing 210 an image representing multiple shingles, multiple roofing tiles and/or multiple wood shakes on a face layer. A face layer and a scrim are combined 220 to form continuous sheet. In one implementation, the face layer and scrim are laminated together. The face layer is also embossed 230. The steps of the method may be performed in any order. In one implementation, the printing is performed after the face layer and scrim are combined and the embossing is performed after the printing. The continuous sheet is large enough to show, for example, an image of multiple courses of shingles in one direction or wood shakes and a plurality of tabs or wood shakes in a perpendicular direction. The continuous sheet may optionally be cut to provide for ease of transportation and/or handling.

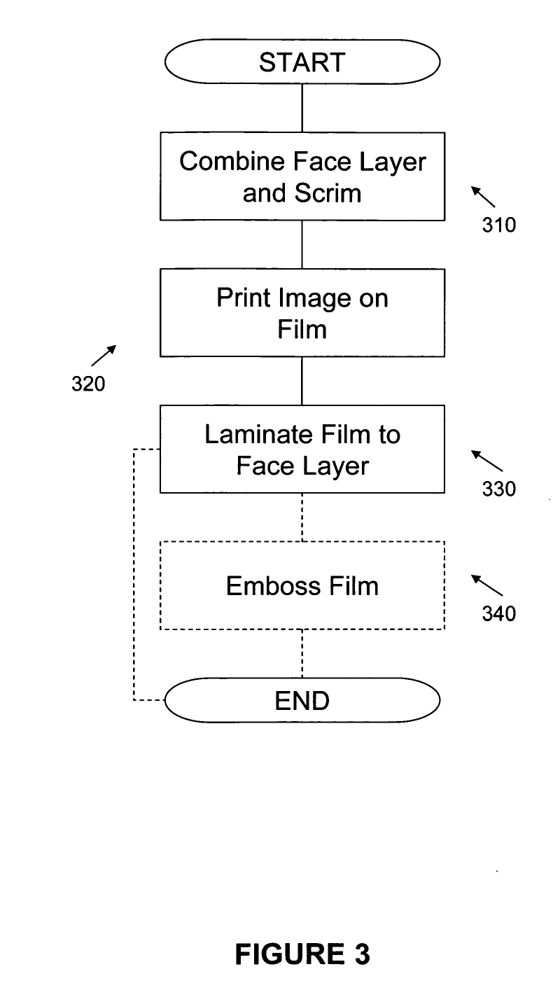

According to another embodiment, a method 300 is illustrated in FIG. 3. This method includes combining 310 a face layer and a scrim to form continuous sheet. An image of multiple shingles, multiple roofing tiles and/or multiple wood shakes is printed 320 on a first side of a transparent or translucent film, such as a protective upper layer. The first side of the film is laminated 330 to the face layer, opposite the scrim. The film may optionally be embossed 340. The steps of this method 300 are not limited to the order described herein, as the printing and lamination may occur before the face layer and scrim are combined.

The printing described herein may involve a wide variety of images. Examples of images can include, but are not limited to, asphalt shingles, roofing tiles, wood shakes and camouflage. Examples of roofing tiles can include Spanish clay tiles and slate. Further examples of images can include customized messages, logos or any image desired to be viewed on a roof. In one implementation, shadows can also be incorporated into the image. For example, shadows of one course of shingles can be shown in the image to be cast on a neighboring course of shingles, thereby enhancing the realistic impression of the roofing product in its attempt to appear to be a common roofing product, such as shingles. In one implementation, a printed image can be oriented in any direction on the face layer and/or protective upper layer.

Examples of printing include: multi-color, rotogravure printing, inkjet printing, digital printing, UV cure printing. Examples of ink include those known in the art for use with vinyl and other plastics. Another example of ink is polyvinylidene fluoride (PVDF) ink.

Embossing may be performed on the face material 110 and/or the protective upper layer 140 before, during or after assembly with other components of the roofing product. In one implementation, details of the embossing, such as the depth and/or size of indentations, are specified. Such details may also be unspecified and/or random.

In one implementation of an illustrative embodiment of the invention, roofing granules, such as those found on asphalt shingles, may be applied to the face material 110 and/or the protective upper layer 140 prior to embossing.

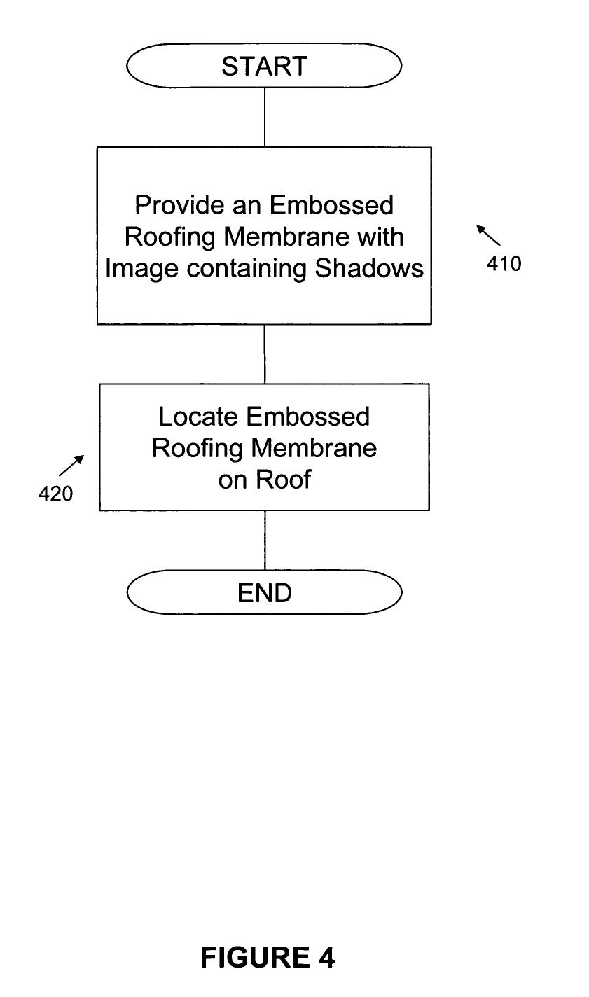

With reference to FIG. 4, a further embodiment of the present invention provides a method 400 of installation of a roofing product. The method includes providing 410 an embossed roofing membrane having an image representing multiple courses of shingles, roofing tiles and/or wood shakes and representations of shadows formed by a first course and located on a second course. The embossed roofing membrane is located 420 on a roof such that the representations of shadows are located below the course of shingles, roofing tiles or wood shakes to which the representations of shadows correspond.

When installing the roofing product, pressure treated wood may optionally be used as blocking around the complete edge of the roof. An optional layer of foil-faced polystyrene insulation may be installed directly over any existing shingles or metal roof. The roofing membrane may be installed over the insulation. The membrane may be secured along the perimeter of the roof with a termination bar, at any side lap seams and along the ridge seam. Optionally, additional components may be used to trim around obstructions on a roof, such as pipes and chimneys. Examples of such components include one-piece vent boots, prefabricated edge details and a ridge vent. Examples of materials for these components include wood, metal and/or rigid vinyl. Optionally, these components may be coated with the roofing membrane so as to match the appearance of other parts of the roof. A wide variety of fasteners may be used. Examples include mechanical fasteners, adhesives, magnetic attraction fasteners, self-adherence and hook-and-loop fasteners. One example of a hook-and-loop fastener is VELCRO®, available from Velcro Industries B.V. of Curacao, Netherlands Antilles.

The present invention has been described by way of example, and modifications and variations of the described embodiments will suggest themselves to skilled artisans in this field without departing from the spirit of the invention. Aspects and characteristics of the above-described embodiments and implementations may be used in combination. The described embodiments and implementations are merely illustrative and should not be considered restrictive in any way. The scope of the invention is to be measured by the appended claims, rather than the preceding description, and all variations and equivalents that fall within the range of the claims are intended to be embraced therein.

What is claimed is:

1. A method for forming a roofing product, including:
printing an image on a face layer, the image representing at least one of the group of multiple shingles, multiple roofing tiles and multiple wood shakes;
combining the face layer and a scrim to form a continuous sheet; and
embossing the face layer.

2. The method of claim 1, further comprising, combining a back layer to the scrim, opposite the face layer.

3. The method of claim 1, further comprising, before the embossing step, providing a protective upper layer to the face layer, opposite the scrim.

4. The method of claim 3, wherein the providing step is performed by top coating.

5. The method of claim 3, wherein the providing step is performed by laminating a film to the face layer.

6. The method of claim 3, wherein the providing step provides polyvinylidene fluoride.

7. The method of claim 1, wherein the printing step prints the image representing multiple shingles and also includes printing the representation of shadows formed by multiple shingles on corresponding neighboring shingles in the image.

8. The method of claim 1, wherein the continuous sheet is formed in an elongated configuration and an orientation of courses of the multiple shingles is perpendicular to a length of the elongated configuration.

9. The method of claim 1, wherein, in the combining step, the face layer includes ketone ethylene ester.

10. The method of claim 1, wherein, in the combining step, the face layer includes thermoplastic polyolefin.

11. The method of claim 10, wherein, in the combining step, the face layer includes a filler combined with the thermoplastic polyolefin.

12. The method of claim 1, wherein, in the combining step, the face layer includes chlorosulfonated polyethylene.

13. The method of claim 1, wherein, in the combining step, the face layer includes chlorinated polyethylene.

14. The method of claim 1, wherein, in the combining step, the face layer includes ethylene propylene diene monomer.

15. The method of claim 1, wherein, in the combining step, the face layer includes metallocene-catalyzed polyethylene.

16. The method of claim 1, wherein, in the combining step, the face layer includes thermoplastic vulcanizate.

17. The method of claim 1, wherein, in the combining step, the face layer includes thermoplastic elastomer.

18. The method of claim 1, wherein, in the combining step, the face layer includes polyvinylidene fluoride.

19. The method of claim 1, wherein, in the combining step, at least one of the group of silica based fillers, foaming agents, ceramics, and microspheres is provided in the face layer.

20. The method of claim 1, wherein, in at least one of the steps of combining or printing, thermochromic materials are added to alter a color of the roofing product.

21. The method of claim 1, further comprising, prior to embossing, adding roofing granules to the face layer.

22. The method of claim 1, further comprising, using phosphorescent pigment in at least one of the group of an ink used in the printing step, the face layer and a protective upper layer located on the face layer.

23. The method of claim 1, further comprising, combining at least one of the group of radio frequency shielding material and electromagnetic shielding material with the continuous sheet.

24. The method of claim 1, wherein in the printing step, the image represents the multiple shingles.

25. The method of claim 1, wherein in the printing step, the image represents the multiple roofing tiles.

26. A method for forming a roofing product, including:
combining a face layer and a scrim to form continuous sheet;
providing a film having a first side and a second side, the film being at least one of the group of transparent and translucent;
printing an image on the first side of the film, the image representing at least one of the group of multiple shingles, multiple roofing tiles and multiple wood shakes; and
laminating the first side of the film to the face layer, opposite the scrim.

27. The method of claim 26, further comprising embossing the film.

28. A method of installation of a roofing product, comprising:
providing an embossed roofing membrane having an image representing multiple courses of at least one of the group of shingles, roofing tiles and wood shakes and representations of shadows formed by a first course and located on a second course; and
locating the embossed roofing membrane on a roof such that the representations of shadows are located below the course of shingles, roofing tiles or wood shakes to which the representations of shadows correspond.

29. The method of claim 28, wherein in the providing step, the image represents the multiple courses of the roofing tiles.
